(19) United States
(12) Patent Application Publication
(10) Pub. No.: US 2015/0307964 A1
(43) Pub. Date: Oct. 29, 2015

(54) Method of Recovering Indium Oxides From Low Grade Indium Containing Residue

(71) Applicant: TORECOM Corporation, Chungcheongnam-do (KR)

(72) Inventors: Young-Myoung Seo, Seoul (KR); Yoo-Sang Shim, Seoul (KR); Sung Chen Ahan, Seoul (KR)

(21) Appl. No.: 14/618,528

(22) Filed: Feb. 10, 2015

(30) Foreign Application Priority Data
Apr. 23, 2014 (KR) 10-2014-0048440

(51) Int. Cl. C22B 58/00; C22B 25/00; B22D 21/00; C22B 7/00

(52) U.S. Cl. CPC C22B 58/00; C22B 7/006; C22B 7/001; C22B 25/00; B22D 21/007; C01P 2002/70

(57) ABSTRACT

A method for recovering indium oxide from a indium-containing residue includes putting tin and an indium-containing residue into a melting furnace, melting the indium-containing residue, generating fume oxide through a reaction of indium and oxygen in the melting furnace, flowing the exhaust gas into a scrubber, spraying a scrubber-circulating liquid toward the exhaust gas in the scrubber, collecting indium oxide included in the exhaust gas with the scrubber-circulating liquid through a gas-liquid contact, performing a first collection of indium oxide through a separation of solid from liquid in a centrifuge, flowing the exhaust gas passed through the scrubber into a bag filter, performing a second collection of indium oxide included in the exhaust gas in the bag filter, flowing the exhaust gas passed through the bag filter into an absorption tower, and removing odors and toxic components generated in the exhaust gas in the absorption tower filled with an activated carbon.

### CROSS-REFERENCE TO RELATED APPLICATION

This application claims priority to and the benefit of Korean Patent Application No. 10-2014-0048440, filed on Apr. 23, 2014, the disclosure of which is incorporated herein by reference in its entirety.

### BACKGROUND

1. Technical Field

This document discloses a method for recovering indium oxides, and more particularly, a method for effectively recovering indium-containing oxides from low-grade, indium-containing residues.

2. Description of the Related Art

Indium (In) used in transparent conductive films is in the form of indium-tin oxide (ITO), which accounts for 70-80% of the total indium market. Transparent conductive films are used in flat panel displays (FPDs) for wide-screen televisions and in liquid-crystal panel displays for computers. Further, low-melting-point alloys that include indium are replacing lead solders as the European Union (EU) strengthens it lead regulations. As a result, the demand for indium is increasing, and indium may be difficult to secure as a raw material. As a result, methods for recovering indium from industrial waste streams are being developed, not just for environmental reasons, but for material recovery purposes.

Further, there is no primary ore from which indium is extracted. Instead, indium is produced industrially by recovering indium from residues generated by smelting zinc or lead, or by recovering indium concentrated in the fumes produced by smelting zinc or lead. Typically, indium recovery methods include wet leaching methods and solvent extraction methods. However, a low-grade-indium-containing residue is generated by both of these methods. Further, conventional indium recovery methods have a limited recovery rate or yield and therefore there is a growing need for methods that increase the indium recovery rate.

### SUMMARY OF THE DISCLOSURE

This document discloses an indium oxide recovery method capable of increasing the indium recovery rate by recovering indium-containing oxide from a low-grade-indium-containing residue containing indium (In) in a short period of time.

According to one aspect, a method of recovering indium oxides from an indium-containing residue includes: (a) preparing an indium-containing residue generated in a wet leaching or solvent extraction process to extract indium contained in indium-tin oxide; (b) putting tin into a melting furnace; (c) putting the indium-containing residue into the melting furnace, melting the indium-containing residue, and generating fume oxides through a reaction of indium and oxygen in the melting furnace; (d) flowing an exhaust gas including the fume oxide into a one or more scrubbers, and spraying a scrubber-circulating liquid toward the exhaust gas in the one or more scrubbers; (e) collecting indium oxide included in the exhaust gas with the scrubber-circulating liquid through a contact of gas and liquid to send to a centrifuge, and performing a first collection of indium oxide through a separation of solid from liquid in the centrifuge; (f) flowing the exhaust gas passed through the scrubber into a bag filter, and performing a second collection of Indium oxide included in the exhaust gas in the bag filter, and (g) flowing the exhaust gas passed through the bag filter into an absorption tower, and removing odors and toxic components in the exhaust gas in the absorption tower filled with an activated carbon.

The method of recovering indium oxide from an indium-containing residue may further include recovering indium oxide from skimming dross formed on a surface of a melt remaining in the melting furnace after step (c), and obtaining coagulated crude Sn by casting the melt remaining in the melting furnace into a mold.

In step (c), a carbon may be added to the melting furnace to accelerate melting oxidation.

The carbon may be preferably added at a rate of 1/10 to 1/5 (weight ratio) with respect to a total content of indium contained in the indium-containing residue.

In the scrubber-circulating liquid, sodium hydroxide (NaOH) may be added to remove chlorine (CI) components contained in the exhaust gas.

The melting furnace may be heated to a temperature higher than 600° C. to increase melt-oxidation effectiveness.

The scrubber-circulating liquid, which is discharged from the centrifuge, may be preferably reflowed into the one or more scrubbers and circulated.

The features, functions, and advantages discussed above may be achieved independently in various embodiments or may be combined in yet other embodiments, further details of which can be seen with reference to the following description and drawings.

### BRIEF DESCRIPTION OF THE DRAWINGS

For a more complete understanding of the disclosed methods and apparatuses, reference should be made to the embodiments illustrated in greater detail in the accompanying drawings, wherein:

FIG. 1 schematically illustrates an indium oxide recovery device including a melting furnace, first and second scrubbers, a centrifuge, a bag filter, and an absorption tower; and

FIG. 2 is an X-ray diffraction (XRD) analysis for indium oxide collected in Experimental Example 1.

The drawings are not necessarily to scale and illustrate the disclosed embodiments diagrammatically and in partial views. In certain instances, this disclosure may omit details which are not necessary for an understanding of the disclosed methods and apparatuses or which render other details difficult to perceive. Further, this disclosure is not limited to the particular embodiments illustrated herein.

### DETAILED DESCRIPTION OF THE PRESENTLY PREFERRED EMBODIMENTS

This disclosure proposes a method of recovering indium oxide capable of increasing a recovery rate of indium (In) by recovering indium-containing oxide (hereinafter referred to as “indium oxide”) from a low-grade-indium-containing residue in a short time.

A method of recovering indium oxide from an In-containing residue according to an exemplary embodiment includes: (a) preparing an In-containing residue generated in a wet leaching or solvent extraction process to extract In contained in indium-tin oxide (ITO); (b) putting tin (Sn) into a melting furnace; (c) putting the In-containing residue into the melting furnace, melting the In-containing residue, and generating fume oxide through a reaction of In and oxygen in the melting furnace; (d) flowing an exhaust gas including the fume oxide into at least one scrubber, and spraying a scrubber-circulating liquid toward an exhaust gas in the scrubber, (e) collecting indium oxide included in the exhaust gas with the scrubber-circulating liquid through a gas-liquid contact to send to a centrifuge, and performing a first collection of indium oxide through a separation of solid from liquid in the centrifuge; (f) flowing the exhaust gas passed through the scrubber into a bag filter, and performing a second collection of indium oxide included in the exhaust gas in the bag filter, and (g) flowing the exhaust gas passed through the bag filter into an absorption tower, and removing odors and toxic components from the exhaust gas in the absorption tower filled with an activated carbon.

ITO or the like generated in an electronic scrap such as a portable device, or in an ITO manufacturing process is collected. The collected ITO is pulverized or classified. A first recovery of In from pulverized or classified ITO is performed, and the first recovery of In may be performed using a wet leaching or solvent extraction method based on hydrochloric acid (HCl). In the first recovery process of In using the wet leaching or solvent extraction method, a low-grade-In-containing residue is generated. The low-grade-In-containing residue contains In at a range of 0.5 to 5 wt %, and most of the remaining residue is Sn. Other components such as copper (Cu), zinc (Zn), and the like are also contained.

A dry melt-oxidation is performed on the low-grade-In-containing residue generated in the first In recovery process, independently or with an additive (carbon), the residue is volatilized to be in a form of fume oxide containing In, and then included in an exhaust gas. A gas-liquid contact is performed with respect to the exhaust gas in one or more scrubbers (e.g., first and second scrubbers), a scrubber-circulating liquid, which includes indium oxide, is collected, and then indium oxide is recovered through a separation of solid from liquid in a centrifuge. Further, a powder of In-containing fume oxide, which is not collected in the first and the second scrubber passes through a bag filter, and finally indium oxide is collected and recovered. The exhaust gas passed through the bag filter flows into an absorption tower, and odors and other toxic components generated in the exhaust gas are removed at the absorption tower filled with an activated carbon.

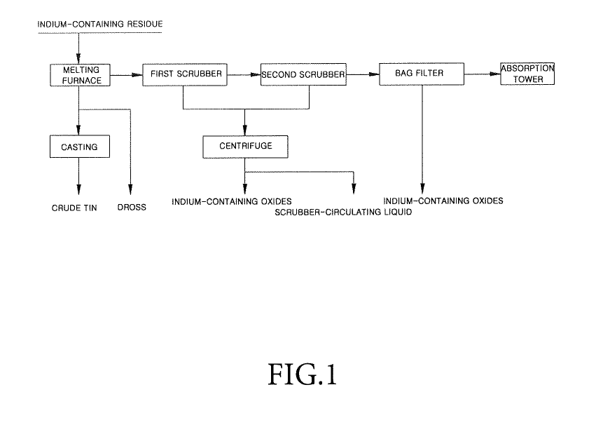

Hereinafter, referring to FIG. 1, a method of recovering indium oxide from a low-grade-In-containing residue generated in a first In recovery process will be described in detail. FIG. 1 schematically illustrates an indium oxide recovery device including a melting furnace, first and second scrubbers, a centrifuge, a bag filter, and an absorption tower.

When a dry melt-oxidation is performed on the low-grade-In-containing residue generated in the first In recovery process, independently or with an additive (carbon), In-containing fume oxide is volatilized and included in an exhaust gas. As the melting furnace for the dry melt-oxidation, a high-frequency-induction melting furnace may be used. Through high-frequency-induction melting, In contained in a low-grade-In-containing residue is reacted with oxygen in the atmosphere in a molten metal at a temperature of 600° C. or more (e.g., 600 to 1,000° C.), and most of the In is volatilized to be in a form of fume oxide.

Although the low-grade-In-containing residue may be added into the melting furnace independently, more preferably, a carbon (e.g., activated carbon) may be added to accelerate a melt-oxidation reaction of the low-grade-In-containing residue.

When the low-grade-In-containing residue is independently added into the melting furnace, a reaction occurs as the following Formula 1. When the low-grade-In-containing residue is added into the melting furnace with a carbon as an additive, a reaction occurs as the following Formula 2.

2InCl₃+1.5O₂(g)=In₂O₃+3Cl₂(g),G=−1.537 kcal at 600° C. [Formula 1]

2InCl₃+3.5O₂(g)+2C=In₂O₃+3Cl₂(g)+2CO₂(g),G=−190.674 kcal at 600° C. [Formula 2]

When Formula 1 is compared with Formula 2, the case of adding the carbon as an additive is determined to accelerate a melt-oxidation reaction. It is preferable that the carbon is added at a rate of 1/10 to 1/5 (weight ratio) with respect to a content of In in the low-grade-In-containing residue. As determined by a thermodynamic calculation, a melting temperature for melt-oxidation should be performed at a temperature of at least 600° C. or more (e.g., 600 to 1,000° C.).

Sn may be added to the melting furnace to form a molten metal at first and then, low-grade-In-containing residue is put into the molten metal, before performing a dry melt-oxidation process. Here, it is preferable that a temperature of the molten metal is maintained at 600° C. or more (e.g., in a range of 600 to 1,000° C.).

When the low-grade-In-containing residue is put into the molten metal after the molten metal is formed, In components contained in the residue are reacted with oxygen (O₂) in the atmosphere to become indium oxide (In₂O₃), volatilized to a form of fume oxide, and discharged to a first scrubber. Sn components contained in the In-containing residue remain in a molten state, and when casting the melt into a mold, coagulated crude Sn may be obtained.

Further, since a trace amount of indium oxide is present even in dross formed on a surface of the molten metal, indium oxide may be recovered by skimming the dross formed on the surface of the molten metal.

After a gas-liquid contact is performed with respect to the exhaust gas discharged from the melting furnace in a one or more scrubbers (first and second scrubbers), a scrubber-circulating liquid, which includes indium oxide, is collected, and then indium oxide is recovered through a separation of solid from liquid in a centrifuge. The first and the second scrubbers are mounted to connect to the melting furnace for collecting indium oxide, and the exhaust gas discharged from the melting furnace sequentially passes through the first scrubber and the second scrubber. In the first and the second scrubbers, a scrubber-circulating liquid is sprayed toward the exhaust gas discharged from the melting furnace, and the scrubber-circulating liquid, which was sprayed flows into a centrifuge mounted on a lower part of the first scrubber. The centrifuge mounted on the lower part of the first scrubber collects indium oxide included in the scrubber-circulating liquid by filtering. The first and the second scrubbers may be filled with fillers capable of accelerating a gas-liquid reaction.

On the other hand, since the low-grade-In-containing residue contains chlorine (CI) components, Cl components may be removed from the exhaust gas by adding sodium hydroxides (NaOH) into the scrubber-circulating liquid. As the low-grade-In-containing residue is mainly generated and discharged in a wet leaching or solvent extraction process based on hydrochloric acid (HCl), in order to remove Cl components contained in the low-grade-In-containing residue, a certain amount of neutralizing agent (NaOH) is added into the scrubber-circulating liquid sprayed from the first and the second scrubbers, thereby removing the Cl components.

The scrubber-circulating liquid discharged from the centrifuge is reflowed into the one or more scrubbers and circulated. A bag filter capable of collecting a powder of indium oxide, which could not be recovered even through a gas-liquid contact, is mounted on back ends of the one or more scrubbers. Fume oxide containing the powder of indium oxide, which was not collected in the first, and the second scrubbers passes through the bag filter, and then indium oxide is finally collected and recovered.

An exhaust gas passed through the bag filter flows into an absorption tower, and odors and other toxic components are removed in the absorption tower filled with an activated carbon. A back end of the bag filter includes the absorption tower filled with the activated carbon capable of removing odors and noxious materials of the exhaust gas. Odors and other toxic components are removed in the absorption tower filled with the activated carbon.

When the above-described process is used, a recovery rate of indium oxide recovered from the low-grade-In-containing residue of 50% or more may be obtained. Hereinafter, an experimental example according to one embodiment will be described in detail, but this disclosure is not limited to the experimental example described below.

### Experimental Example 1

In order to collect and recover indium oxide, an indium oxide recovery device mounted with a melting furnace, first and second scrubbers, a centrifuge, a bag filter and an absorption tower, as illustrated in FIG. 1, was used. As the melting furnace for dry melt-oxidation, a high-frequency-induction melting furnace was used.

150 g of a low-grade-In-containing residue having an In content of 1.16 wt % was used as a raw material, and here, a content of moisture contained in the In-containing residue was 12.8 wt %. Further, the remaining component excluding In was 86.2 wt % of Sn.

After a molten metal was formed by putting 145 g of Sn with a purity of 4N into the high-frequency-induction melting furnace at first, the low-grade-In-containing residue was put into the melted molten metal. Here, a temperature of the molten metal was maintained at 600° C. or more. Further, 10 g of a carbon was put into the melting furnace to accelerate a melt-oxidation reaction.

After the molten metal was formed, when the low-grade-In-containing residue was put into the molten metal, Sn components contained in the In-containing residue was melted, and coagulated to be crude Sn through casting into a mold. Then, In components contained in the In-containing residue reacted with O₂ in the atmosphere to be indium oxide (In₂O₃), volatilized to be in a form of fume oxide, and included in an exhaust gas to be discharged to the first scrubber.

When the exhaust gas went through the first and the second scrubbers, indium oxide was included in a scrubber-circulating liquid and collected. The indium oxide included in the scrubber-circulating liquid was recovered through a separation of solid from liquid using the centrifuge.

Further, since a trace amount of indium oxide was present in dross formed on a surface of the molten metal, the indium oxide was recovered by skimming the dross formed on a surface of the molten metal.

A powder of indium oxide, which was not collected in the first, and the second scrubbers was collected and recovered in the bag filter.

A mass balance of the present Experimental Example 1 was represented in the following Table 1. In the following Table 1, indium oxide of the output indicate a sum of a content of In recovered from the centrifuge and a content of In recovered from the bag filter. A recovery rate was represented by dividing a sum of content (B) of In collected from the centrifuge and the bag filter and content (C) of indium oxide collected from the dross by content (A) of In contained in the low-grade-In-containing residue, and expressing as a percentage.

TABLE 1

| | | Weight | In | | Sn | |
|---|---|---|---|---|---|---|
| Classification | | (g) | wt % | Metal(g) | wt % | Metal(g) |
| Input | Low-grade | 130.7 (dry) | 1.16 | 1.52 | 86.2 | 112.66 |
| | In-con- | | | | | |
| | taining | | | | | |
| | residue | | | | | |
| | Sn | 145 | — | — | 99.99 | 145 |
| | Carbon | 6 | — | — | — | — |
| | Total | 275.7 | — | 1.52 (A) | — | 257.66 |
| Out- | Crude Sn | 158.13 | 0.2 | 0.32 | 99 | 156.55 |
| put | Indium | 22.22 | 4.4 | 0.97 (B) | 90 | 20 |
| | Oxide | | | | | |
| | Dross | 111.73 | 0.21 | 0.23 (C) | 72.6 | 81.11 |
| | Total | 292.08 | — | 1.52 | — | 257.66 |

| | | | |
|---|---|---|---|
| Recovery | (B + C)/ | 78.9% | — |
| | A (%) | | |

As shown in Table 1, the recovery rate of indium oxide recovered from the low-grade-In-containing residue was represented by 78.9%. It was determined that additional In may be recovered from a conventional waste residue through the experimental example.

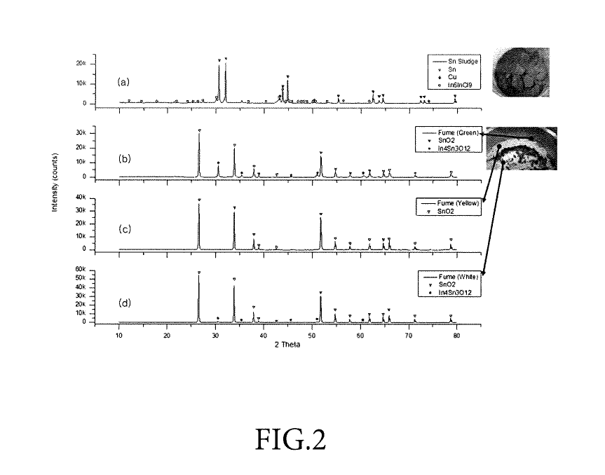

Further, an image analysis on indium oxide recovered as above was performed through an X-ray diffraction (XRD) analysis, and results were represented in FIG. 2. In FIG. 2, (a) relates to the low-grade-In-containing residue, and (b), (c), and (d) relate to recovered indium oxide. As shown in FIG. 2, it was determined that recovered oxide was indium oxide.

Accordingly, In-containing oxide can be recovered from a low-grade-In-containing residue in a short time, thereby increasing a recovery rate of indium oxide.

After a first recovery of In contained in ITO is performed using a wet leaching method and a solvent extraction method, a second recovery of In-containing oxides from a low-grade-In-containing residue generated in the wet leaching or solvent extraction processes is performed, thereby enabling a total recovery rate of In to increase.

While only certain embodiments of been set forth, alternative embodiments and various modifications will be apparent from the above description to those skilled in the art. These and other alternatives are considered equivalents and within the spirit and scope of the present disclosure.

What is claimed:

1. A method for recovering indium oxide from an indium-containing residue, the method comprising:
(a) preparing an indium-containing residue generated in a wet leaching or solvent extraction process to extract indium (In) contained in indium-tin oxide;
(b) putting tin into a melting furnace;
(c) putting the indium-containing residue into the melting furnace, melting the indium-containing residue, and generating fume oxide through a reaction of indium and oxygen in the melting furnace;
(d) flowing an exhaust gas including the fume oxide into one or more scrubbers, and spraying a scrubber-circulating liquid toward the exhaust gas in the one or more scrubbers;
(e) collecting indium oxide included in the exhaust gas with the scrubber-circulating liquid through a gas-liquid contact to send to a centrifuge, and performing a first collection of indium oxide through a separation of solid from liquid in the centrifuge;
(f) flowing the exhaust gas passed through the scrubbers into a bag filter, and performing a second collection of indium oxide included in the exhaust gas in the bag filter; and
(g) flowing the exhaust gas passed through the bag filter into an absorption tower, and removing odors and toxic components in the exhaust gas in the absorption tower filled with an activated carbon.

2. The method of claim 1, further comprising:
recovering indium oxide from skimming dross formed on a surface of a melt remaining in the melting furnace after the step (c); and
obtaining coagulated crude Sn by casting the melt remaining in the melting furnace into a mold.

3. The method of claim 1, wherein a carbon is additionally put into the melting furnace to accelerate melt-oxidation in the step (c).

4. The method of claim 3, wherein the carbon is added at a rate of 1/10 to 1/5 (weight ratio) with respect to a total content of indium contained in the indium-containing residue.

5. The method of claim 1, wherein sodium hydroxide (NaOH) is added in the scrubber-circulating liquid to remove chlorine (Cl) components contained in the exhaust gas.

6. The method of claim 1, wherein the melting furnace is heated to a temperature higher than 600° C. to increase melt-oxidation effectiveness.

7. The method of claim 1, wherein the scrubber-circulating liquid, which is discharged from the centrifuge is reflowed into the one or more scrubbers and circulated.

8. A method for extracting indium oxide, the method comprising:
(a) putting tin into a melting furnace;
(b) putting an indium-containing residue into the melting furnace, melting the tin and the indium-containing residue, and generating an exhaust gas that includes indium oxide from a reaction of indium and oxygen in the melting furnace;
(c) flowing the exhaust gas into a scrubber and contacting a scrubber-circulating liquid with the exhaust gas to transfer indium oxide from the exhaust stream to the scrubber-circulating liquid;
(d) collecting the scrubber-circulating liquid and sending the scrubber-circulating liquid to a centrifuge, and performing a first collection of indium oxide through a separation of indium oxide from the scrubber-circulating liquid in the centrifuge;
(e) flowing the exhaust gas from the scrubber to a bag filter, and performing a second collection of indium oxide included in the exhaust gas in the bag filter; and
(f) flowing the exhaust gas from the bag filter into an absorption tower, and removing odors and toxic components in the exhaust gas in the absorption tower filled with an activated carbon.

9. The method of claim 8, further comprising:
recovering indium oxide from skimming dross formed on a surface of a melt remaining in the melting furnace after the step (b); and
obtaining coagulated crude Sn by casting the melt remaining in the melting furnace into a mold.

10. The method of claim 8, wherein a carbon is additionally put into the melting furnace to accelerate melt-oxidation in the step (b).

11. The method of claim 10, wherein the carbon is added at a rate of 1/10 to 1/5 (weight ratio) with respect to a total content of indium contained in the indium-containing residue.

12. The method of claim 8, wherein sodium hydroxide (NaOH) is added in the scrubber-circulating liquid to remove chlorine (Cl) components contained in the exhaust gas.

13. The method of claim 8, wherein the melting furnace is heated to a temperature higher than 600° C. to increase melt-oxidation effectiveness.

14. The method of claim 7, wherein the scrubber-circulating liquid, which is discharged from the centrifuge, is reflowed into the scrubber and circulated.
